(19) United States
(12) Patent Application Publication
(10) Pub. No.: US 2021/0252556 A1
(43) Pub. Date: Aug. 19, 2021

(54) WASTE SORTING FACILITY AND WASTE SORTING METHOD

(71) Applicant: SUZUKEN KOGYO CO., LTD., Fuefuki-shi, Yamanashi (JP)

(72) Inventor: Yasunobu SUZUKI, Fuefuki-shi (JP)

(73) Assignee: SUZUKEN KOGYO CO., LTD., Fuefuki-shi, Yamanashi (JP)

(21) Appl. No.: 17/049,253

(22) PCT Filed: Feb. 14, 2019
(86) PCT No.: PCT/JP2019/005326

§ 371 Date: Oct. 20, 2020

(51) Int. Cl. B07C 5/02; B07C 5/36; B09B 3/00

(52) U.S. Cl. CPC B07C 5/02; B07C 5/36; B07C 2501/0063; B07C 2501/0054; B09B 3/00

(57) ABSTRACT

A waste sorting facility for sorting wastes includes: a steel conveyor belt that conveys the wastes; backhoes disposed in a conveying direction (X direction) of the wastes so as to face the steel conveyor belt and capable of removing a constituent that constitutes the wastes from the steel conveyor belt; constituent placement parts on which the constituent removed from the steel conveyor belt is placed, the constituent placement parts being disposed so as to face the steel conveyor belt; and a fluid spraying mechanism capable of spraying foam or liquid to a surface of the constituent on the steel conveyor belt. The fluid spraying mechanism includes fluid spraying machines that spray the foam upstream of the backhoes in the steel conveyor belt. This configuration can reduce the load of the waste sorting facility on the surrounding environment.

### TECHNICAL FIELD

The present invention relates to a waste sorting facility and a waste sorting method.

### BACKGROUND ART

A waste sorting facility described in Patent Literature 1 includes a working machine, and a handling mechanism including an articulated arm mechanism.

This can reduce the direct exposure of the human body as much as possible in the waste sorting facility. Even if wastes to be treated release bad odor as a result of putrefaction or discharge a large amount of dust, the waste sorting facility described in Patent Literature 1 can significantly reduce a load on a worker from a hygiene perspective.

### CITATION LIST

### Patent Literature

Patent Literature 1: Japanese Patent Application Laid-Open No. 2015-128763

### SUMMARY OF INVENTION

### Technical Problem

In reality, however, even the waste sorting facility of Patent Literature 1 also requires some workers compelled to work with their bodies having direct exposure. Furthermore, a place to provide a waste sorting facility is not necessarily confined to a place far from town. In some cases, such a waste sorting facility may have to be provided near residences in the future. Actually, a problem such that troubles with the neighborhood regarding the construction of waste sorting facilities have occurred, and thus a required number of waste sorting facilities cannot be constructed sufficiently is becoming a social problem domestically and abroad.

That is, it is now required to reduce a load on the surrounding environment by reducing dust and bad odor spread from the waste sorting facility as much as possible.

The present invention has been made to solve the aforementioned problems, and an object of the present invention is to provide a waste sorting facility and a waste sorting method capable of reducing the load of the waste sorting facility on the surrounding environment.

### Solution to Problem

The present invention solves the above-described problem by providing a waste sorting facility for sorting wastes, including: a conveying unit that conveys the wastes; one or more first working machines disposed in a conveying direction of the wastes so as to face the conveying unit and capable of removing a constituent that constitutes the wastes from the conveying unit; one or more constituent placement parts on which the constituent removed from the conveying unit by the one or more first working machines is placed, the one or more constituent placement parts being disposed so as to face the conveying unit; and a fluid spraying mechanism capable of spraying foam or liquid to a surface of the constituent on the conveying unit. The fluid spraying mechanism includes a first spraying part that sprays the foam or the liquid upstream of the one or more first working machines in the conveying unit.

According to the present invention, the first spraying part sprays the foam or the liquid upstream of the one or more first working machines in the conveying unit. Thus, when the first spraying part sprays the liquid, at least an amount of dust spread from the constituent on the conveying unit can be reduced. When the first spraying part sprays the foam, the spread of not only dust but also bad odor can be reduced from the constituent on the conveying unit. In addition, risk of flooding the conveying unit can be reduced.

The fluid spraying mechanism may include a second spraying part that sprays the foam or the liquid downstream of the first spraying part in the conveying unit and in the vicinity of the one or more first working machines, and when the second spraying part sprays the foam or the liquid to the constituent which the first working machine comes into contact with, for example, when the second spraying part sprays the liquid, at least the spread of dust generated when the state of the constituent is changed by the first working machine can be reduced. When the second spraying part sprays the foam, the spread of dust and smell generated when the state of the constituent is changed by the first working machine can be reduced. At the same time, risk of flooding the conveying unit can be reduced.

When the second spraying part is provided to the first working machine, a region to be sprayed by the second spraying part can be easily adjusted, and the occurrence of a collision of the first working machine against the second spraying part can be reduced.

When the first spraying part sprays the foam and the second spraying part sprays the liquid, an amount of water used can be significantly reduced as compared to when the first spraying part sprays the liquid. At the same time, since the foam attached to the constituent which the first working machine comes into contact with is made disappear, the constituent that should be sorted by the first working machine can be sorted in a stable manner.

When a third spraying part that sprays in the one or more constituent placement parts the foam or the liquid is further included, at least dust from the constituent to be sorted out and placed on the constituent placement part can be reduced.

When the foam or the liquid contains any of a deodorizer and a fragrance, the spread of bad odor can be reduced.

When the first working machine includes: a traveling body; a revolving body rotatable with respect to the traveling body; an arm body attached to the revolving body so as to be swingable up and down; and a grasping mechanism capable of grasping the constituent and moving the constituent up, down, right, and left by being swingably attached to a leading end of the arm body, sorting can be efficiently performed even when the positions and sizes of the constituents to be sorted are non-uniform.

When a screening unit that screens out the constituent of the wastes having a size smaller than or equal to a predetermined reference size is provided at a preceding stage of the conveying unit, in particular, the constituent can be placed on the conveying unit after the constituent having the size smaller than or equal to the predetermined reference size is removed in advance. Thus, sorting of the wastes on the conveying unit can be further facilitated. When the fluid spraying mechanism includes a fourth spraying part that sprays the foam or the liquid to the wastes on the screening unit, at least the spread of dust generated in the screening unit can be effectively reduced.

When a second working machine that includes the grasping mechanism, grasps the wastes by the grasping mechanism, and feeds the wastes to the screening unit is included, the wastes can be easily transferred to the screening unit.

When the second working machine sprays the foam or the liquid to the wastes, the foam or the liquid can be efficiently sprayed to the wastes before the wastes are fed to the screening unit.

When the fluid spraying mechanism further includes a fourth spraying part that sprays the foam onto the conveying unit before the wastes are placed thereon, the wastes are interposed between the layers of the foam from their top and bottom. This makes it possible to prevent the generation of dust and smell more.

The present invention can also be regarded as a waste sorting method for sorting wastes, including the steps of: spraying foam or liquid to a surface of a constituent that constitutes the wastes on a conveying unit; conveying the constituent, to which the foam or the liquid has been sprayed, by the conveying unit; removing the constituent, to which the foam or the liquid has been sprayed, from the conveying unit by one or more first working machines disposed side by side in a conveying direction of the wastes so as to face the conveying unit; and placing the constituent removed from the conveying unit by the one or more first working machines on one or more constituent placement parts disposed so as to face the conveying unit.

### Advantageous Effects of Invention

According to the present invention, the load of the waste sorting facility on the surrounding environment can be reduced.

### BRIEF DESCRIPTION OF DRAWINGS

FIG. 1 is a schematic diagram illustrating an example of a waste sorting facility according to a first embodiment of the present invention.

FIG. 2 shows schematic diagrams illustrating side views of the waste sorting facility in FIG. 1 (FIG. 2A is a side view when viewed in an X direction and FIG. 2B is a side view when viewed in a Y direction).

FIG. 3 is a schematic diagram illustrating a vibrating screening machine used in the waste sorting facility.

FIG. 4 shows schematic diagrams illustrating a fluid spraying machine that constitutes a fluid spraying mechanism used in the waste sorting facility (FIG. 4A is a front view; FIG. 4B is a side view; FIG. 4C is a top view; and FIG. 4D is a diagram showing a relationship between a rotation angle θ of a rotating member and a tilt angle α of a nozzle in the fluid spraying machine).

FIG. 5 is a schematic diagram illustrating a backhoe used in the waste sorting facility.

FIG. 6 shows schematic diagrams illustrating a frame body and a handling mechanism used in the waste sorting facility (FIG. 6A is a side view when viewed in the X direction and FIG. 6B is a top view).

FIG. 7 is a block diagram of a recognition device and the handling mechanism.

FIG. 8 is a schematic diagram illustrating a sorting procedure in the waste sorting facility.

FIG. 9 is a schematic diagram illustrating examples of a backhoe and a fluid spraying machine according to a second embodiment of the present invention.

FIG. 10 is a schematic diagram illustrating an example of a backhoe according to a third embodiment of the present invention.

### DESCRIPTION OF EMBODIMENTS

An exemplary embodiment of the present invention will be described below in detail with reference to the drawings.

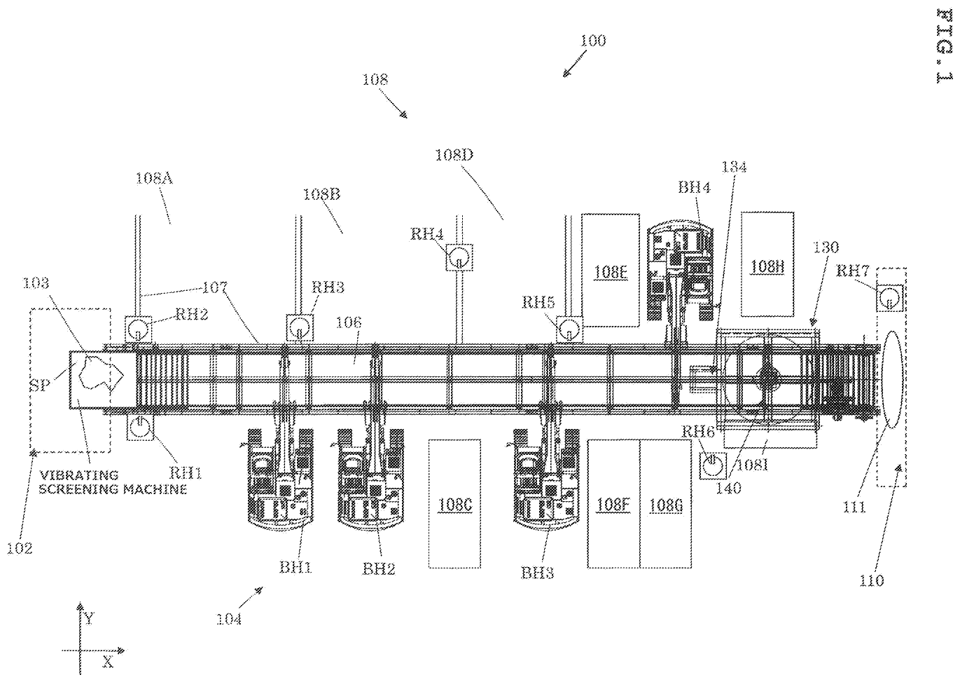

A waste sorting facility according to a first embodiment will be described first with reference to FIGS. 1 to 8.

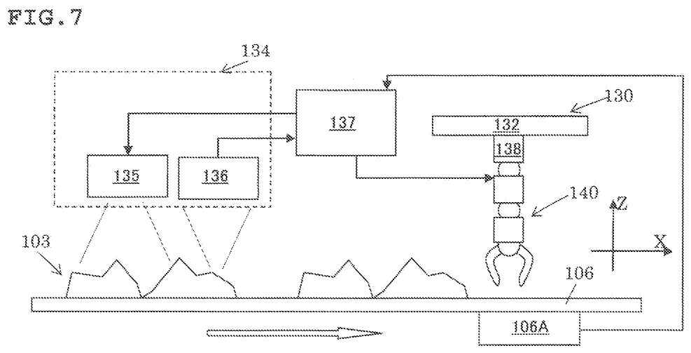

As shown in FIG. 1, a waste sorting facility 100 is configured to sort wastes 103. The waste sorting facility 100 includes: a vibrating screening machine (screening unit) VS in a waste feeding part 102; a steel conveyor belt (conveying unit) 106; one or more backhoes (first working machines) BH1 to BH4 in a working machine disposition part 104; one or more yards (constituent placement parts) 108; a fluid spraying mechanism RH (RH1 to RH7); a residue placement part 110; a recognition device 134; a processing part 137 (FIG. 7); and a handling mechanism 140.

The steel conveyor belt 106 is configured to convey the wastes 103. The one or more backhoes BH1 to BH4 are disposed in a conveying direction (X direction) of the wastes 103 so as to face the steel conveyor belt 106. The one or more backhoes BH1 to BH4 are configured to be capable of removing constituents 103A that constitute the wastes 103 from the steel conveyor belt 106. The yards 108 are disposed so as to face the steel conveyor belt 106, and the constituents 103A removed from the steel conveyor belt 106 by the one or more backhoes BH1 to BH4 are placed on the yards 108. The fluid spraying mechanism RH can spray foam BL or liquid DL to surfaces of the constituents 103A on the steel conveyor belt 106. Note that the fluid spraying mechanism RH includes fluid spraying machines (first spraying part) RH1 and RH2 that spray the foam BL upstream of the one or more backhoes BH1 to BH4 in the steel conveyor belt 106.

Although the wastes 103 in the present embodiment include a large volume of wastes produced by a natural disaster including an earthquake, a seismic sea wave, or a landslide, the wastes 103 also include perishable wastes produced by one's daily life. Specifically, the wastes 103 include, for example, many wood materials made from wood, such as lumber or pieces of wood 103AA, and pieces of paper (constituents 103A). The wastes 103 also include large or small flame-retardant plastics such as polyvinyl chloride pipes, asphalt debris, concrete debris, large or small scrap metal, home appliances such as refrigerators, TVs, and microwave ovens, dangerous articles such as gas cylinders and fire extinguishers, fishing nets, and hazardous articles (constituents 103A). The wastes 103, of course, may be wastes produced when a whole wooden house is torn down, or wastes produced at a construction site of a newbuilding. Proportions of the constituents 103A that constitute the wastes 103 as well as types of the constituents 103A are not limited to those of the present embodiment.

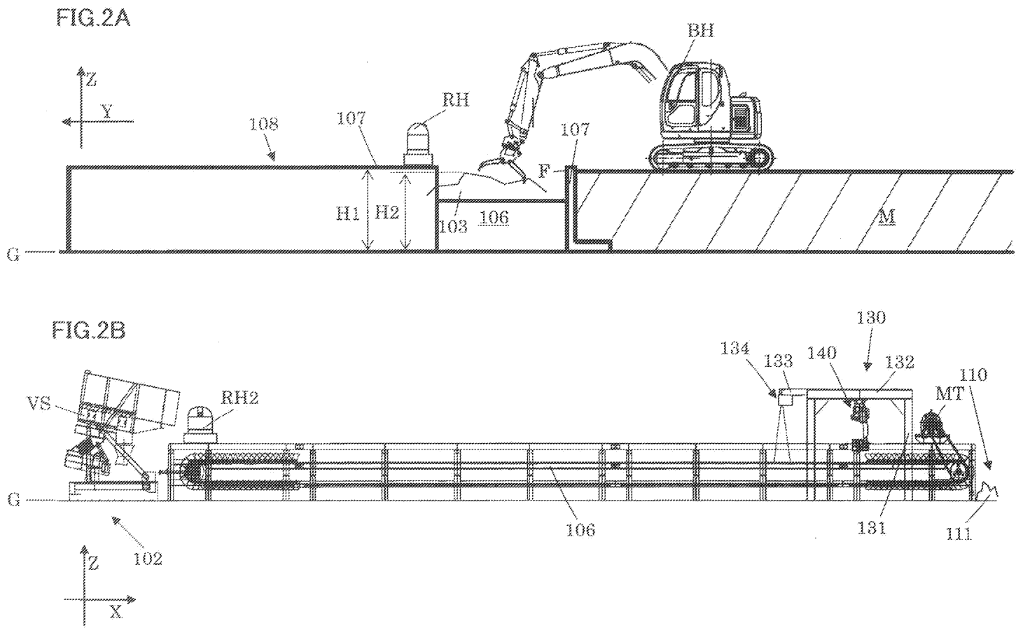

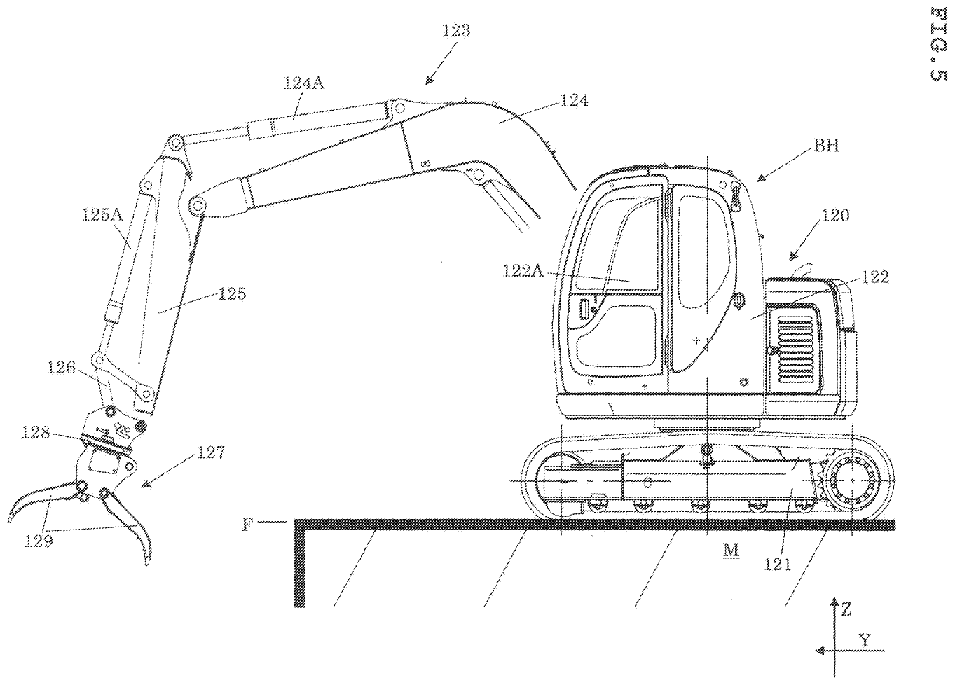

According to the present embodiment, guide walls 107 (a height H1) formed to be higher than a height H2 of the wastes 103 on the steel conveyor belt 106 are provided between the backhoes BH1 to BH4 and the steel conveyor belt 106 and between the steel conveyor belt 106 and the yards 108 as shown in FIGS. 1 and 2A. The guide wall 107 is further provided also for partitioning the yard 108. The working machine disposition part 104 where the backhoes BH1 to BH4 are disposed is at a level F (FIGS. 2A and 5, being elevated by 2 m or 3 m, for example) made higher than a ground level G by forming a mound M on the level G (for the mound M and the ground, the soil need not be exposed, and concrete may be placed thereon, for example). Note that the guide walls 107 (formed to be higher than the height H2 of the wastes 103) and the mound M as described above are not essential.

Components of the waste sorting facility 100 will be described below in detail. Note that configurations of the backhoes BH (BH1 to BH4), the fluid spraying mechanism RH, a frame body 130, the recognition device 134, the processing part 137, and the handling mechanism 140 will be described later.

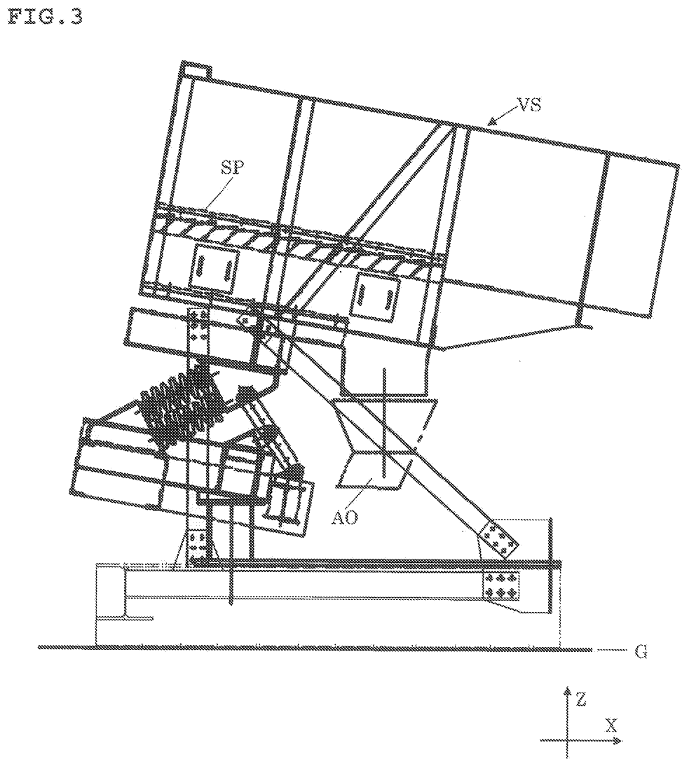

As shown in FIG. 1, the waste feeding part 102 refers to an area provided at a leading end position of the steel conveyor belt 106. The vibrating screening machine (screening unit) VS shown in FIG. 3 is placed in the waste feeding part 102. That is, the vibrating screening machine VS is provided at a preceding stage of the steel conveyor belt 106.

The vibrating screening machine VS includes a slant plane SP of a screen including a mesh-shaped, bar-shaped, comb-teeth, or finger screen, for example. The vibrating screening machine VS vibrates the slant plane SP to move the wastes 103 fed to an upper part of the vibrating screening machine VS toward a lower part of the vibrating screening machine VS along the slant plane SP. The slant plane SP then functions as a screen, and the vibrating screening machine VS is configured to screen out constituents 103A of the wastes 103 having sizes smaller than or equal to a predetermined reference size to the rear side of the slant plane SP (the vibrating screening machine VS may be a grizzly feeder having multiple stages of screening grating). The screened out constituents 103A are collected as residues 111 at a discharge outlet AO. Note that the size smaller than or equal to the predetermined reference size means a size too small to be held by the handling mechanism 140. That is, the vibrating screening machine VS is configured to remove constituents 103A of the wastes 103 not to be removed by the handling mechanism 140 from the steel conveyor belt 106.

The wastes 103 are dumped (unloaded) from a loading platform of a truck (not shown), and a backhoe not shown (second working machine) grasps the piled-up wastes 103 with a grasping mechanism to be described later and feeds the wastes 103 to the vibrating screening machine VS. The vibrating screening machine VS receives the wastes 103 at the slant plane SP, and moves the wastes 103 to the lower part of the vibrating screening machine VS along the slant plane SP. The vibrating screening machine VS then feeds only the wastes 103 moved along the slant plane SP onto the steel conveyor belt 106 in a flattened state. That is, the wastes 103 are fed onto the steel conveyor belt 106 after the piled-up form of the constituents 103A is appropriately diminished and flattened by the vibrating screening machine VS. Note that the screened out wastes 103 are collected as the residues 111 by a wheel loader equipped with a bucket (not shown), for example, and carried to a predetermined treatment site.

As shown in FIG. 1, the working machine disposition part 104 is provided so as to face, or be adjacent to, placement parts 108A to 108H of the yards 108. As shown in FIG. 1, the one or more (four) backhoes (removing unit, the first working machines) BH1 to BH4 are disposed in the working machine disposition part 104. The backhoes BH1 to BH4 are disposed in the conveying direction (X direction) of the wastes 103 so as to face the steel conveyor belt 106. The backhoes BH1 to BH4 are configured to be capable of grasping constituents 103A larger than the sizes of the pieces of wood 103AA to be removed by the handling mechanism 140 and removing such constituents 103A from the steel conveyor belt 106. In the present embodiment, the backhoe BH1 is mainly configured to sort out large lumber, large combustible plastics, and the like as combustible bulky articles from among the wastes 103. The backhoe BH2 is mainly configured to sort out: large scrap metal, concrete debris, large flame-retardant polyvinyl chloride pipes, and the like (non-combustible bulky articles); and home appliances from among the wastes 103. The backhoe BH3 is mainly configured to sort out: home appliances; asphalt debris, concrete debris, and the like (referred to as asphalt concrete); fishing nets; and scrap metal from among the wastes 103. The backhoe BH4 is configured to sort out: fishing nets; dangerous articles; and hazardous articles from among the wastes 103. In the present embodiment, constituents 103A having large volumes occupied in the wastes 103 are sorted out by the upstream backhoes BH1 and BH2. That is, since large-volume items are sorted out first by the backhoes BH1 to BH4, the wastes 103 can be sorted speedily (of course, the number of items may not be associated with the sorting order). Although the four backhoes BH1 to BH4 for sorting are provided in accordance with the number of items and amounts of the constituents 103A in the present embodiment, only a single backhoe may be provided if the number of items of the constituents 103A is few.

As shown in FIG. 1, the steel conveyor belt 106 is disposed approximately at the center of the waste sorting facility 100, and can convey the wastes 103 directly fed from the vibrating screening machine VS in the waste feeding part 102 to the residue placement part 110. In the present embodiment, the steel conveyor belt 106 has a width of about 2 m and a length of about 30 m (the width and the length are not limited thereto). The feed speed of the steel conveyor belt 106 is variable between a few meters per minute and ten and several meters per minute (the maximum conveyed amount is a few tons per minute, for example). Such a feed speed, however, can be set in consideration of the sorting speed of the backhoes BH1 to BH4, the sorting speed of the handling mechanism 140 for the pieces of wood 103AA, and the feed amount of the wastes 103, for example. An upper plate of the steel conveyor belt 106 is made of steel so that the steel conveyor belt 106 is prevented from being mechanically damaged or broken when the wastes 103 are placed thereon or if grapples(grasping mechanism) 127 of the backhoes BH1 to BH4 hit the steel conveyor belt 106 (conversely, the upper plate of the steel conveyor belt 106 needs not be made of steel as long as the steel conveyor belt 106 is prevented from being mechanically damaged or broken when the wastes 103 are placed thereon or if the grapples 127 of the backhoes BH1 to BH4 hit the steel conveyor belt 106). As shown in FIG. 2B, the steel conveyor belt 106 is disposed horizontally. Note that the reference sign MT in FIG. 2B denotes a geared motor, which is a driving source of the steel conveyor belt 106, for example (the driving source is not limited thereto, and another typical power source may be used instead).

As shown in FIG. 1, the yards 108 are disposed so as to face the steel conveyor belt 106. More specifically, the yard 108 is disposed on one side of the steel conveyor belt 106 opposite to the backhoes BH1 to BH4, or disposed alongside of the backhoes BH1 to BH4 with respect to the steel conveyor belt 106 (without being limited to such a disposition, the yards 108 may be disposed between the steel conveyor belt 106 and the backhoes BH1 to BH4). The constituents 103A removed from the steel conveyor belt 106 by the backhoes BH1 to BH4 are placed on the yards 108. In the yards 108, the positions, order, and dimensions of the placement parts 108A to 108H for the constituents 103A are determined on the basis of the number of items, amounts, and sizes of the constituents 103A that constitute the wastes 103. That is, if the number of constituents 103A to be sorted increases, the number of yards 108 (classifications) increases accordingly. In the present embodiment, the yards 108 have placement parts of eight classifications: the combustible bulky article placement part 108A; the non-combustible bulky article placement part 108B; the home appliance placement part 108C; the asphalt concrete placement part 108D; the fishing net placement part 108E; the scrap metal placement part 108F; the dangerous article placement part 108G; and the hazardous article placement part 108H. These yards 108 are disposed in this order start/ing from the upstream side of the steel conveyor belt 106. The spaces of the placement parts 108A to 108H are set so as to become substantially smaller in this order. Each of the placed constituents 103A is loaded onto a truck by a backhoe not shown (a wheel loader equipped with a bucket, for example, may be used without being limited to the backhoe), and carried to a predetermined treatment site (e.g., an incineration site, an intermediate storage site, or a predetermined burial site if directly buried).

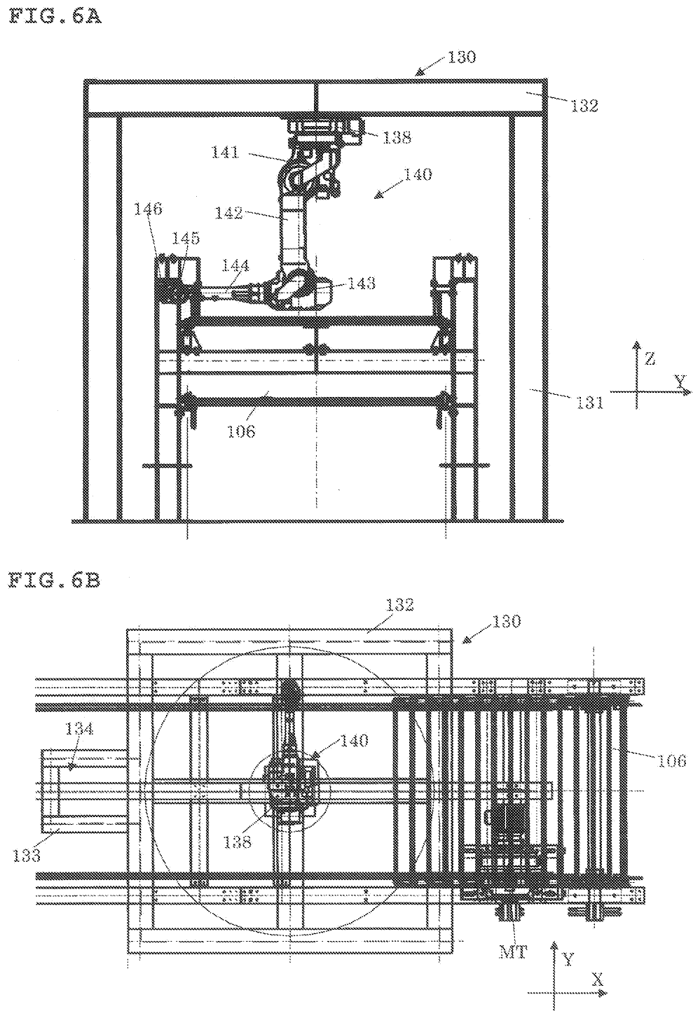

As shown in FIGS. 1, 6A, and 6B, the frame body 130 is provided downstream (subsequent stage) of the working machine disposition part 104 and the yards 108 so as to straddle the steel conveyor belt 106. As shown in FIGS. 2B and 6A, the frame body 130 includes struts 131 and an upper frame 132. As shown in FIG. 1, the struts 131 are fixed to the ground on an outer side of the guide walls 107, and support the upper frame 132. As shown in FIGS. 1 and 6B, the upper frame 132 has a substantially square shape in a plan view (as viewed from above), and includes the handling mechanism 140 in a central portion thereof. The handling mechanism 140 includes a support shaft 138, and the support shaft 138 turnably supports an articulated arm mechanism (which will be described later). That is, the support shaft 138 is provided at a center of a conveying path of the steel conveyor belt 106 in a width direction thereof in a plan view, i.e., within the conveying path. As shown in FIGS. 2B and 6B, an extended frame 133 is provided integrally with the upper frame 132 upstream of the support shaft 138. The extended frame 133 supports the recognition device 134. That is, the vibrating screening machine VS and the backhoes BH are disposed at a preceding stage (upstream) of the recognition device 134, and the handling mechanism 140 is disposed at a subsequent stage (downstream) of the recognition device 134. Note that a wood piece placement part 108I is provided in the vicinity of the frame body 130 so as to be adjacent to the dangerous article placement part 108G. The pieces of wood 103AA sorted out by the handling mechanism 140 are placed on the wood piece placement part 108I. The size of the piece of wood 103AA falls, for example, in a range of a length of about 10 cm (a few centimeters square) to a length of about 1 m (a ten and several centimeters square). Note that a cover (not shown) is provided over the entire frame body 130 including the recognition device 134, the processing part 137, and the handling mechanism 140 as simple measures to prevent dust, wind and rain so as not to disturb the conveyance of the wastes 103 by the steel conveyor belt 106.

As shown in FIGS. 1 and 2B, the residues 111 conveyed by the steel conveyor belt 106 are placed on the residue placement part 110. The steel conveyor belt 106 is provided so as to be higher than the ground level Gas shown in FIGS. 2A and 2B. Thus, by disposing a vibrating screening machine (not shown) at a trailing end of the steel conveyor belt 106, the wastes 103 conveyed by the steel conveyor belt 106 are screened out again, and the remaining wastes 103 are placed on the residue placement part 110 as the residues 111 (without providing such a vibrating screening machine, the remaining wastes 103 may be directly loaded onto a truck, or the like, as the residues 111). The residues 111 are easily collected by a wheel loader equipped with a bucket, for example, and carried to a predetermined treatment site (alternatively, the residues 111 may be conveyed, by a belt conveyor or the like, to a predetermined treatment site where a final sorting step is further performed).

The configurations of the backhoes BH1 to BH4 (BH) will be described next with reference to FIG. 5. The backhoes BH1 to BH4 each have the same configuration in the present embodiment. Note however that the backhoes BH1 to BH4 are of a small type (e.g., class 0.25) so as to be used for sorting. Thus, the backhoes BH1 to BH4 can achieve speedy sorting (the size of the backhoes BH1 to BH4 is not necessarily limited thereto).

As shown in FIG. 5, the backhoe BH includes a vehicle body 120, an arm body 123, and the grapple (grasping mechanism) 127. The vehicle body 120 includes a crawler type traveling body 121, a revolving mechanism, and a revolving body 122. That is, the revolving body 122 is turnable with respect to the traveling body 121 by the revolving mechanism. The revolving body 122 is provided with a driver's seat 122A. The driver's seat 122A is configured to be closable in a sealed manner. The driver's seat 122A can block rain and wind without directly exposing a worker to the environment and can be temperature-regulated by an air conditioner. The driver's seat 122A may be provided with a shield for reducing the influence of radioactivity from radioactive materials, or may be further added with an air filter for preventing the entry of dust if needed. That is, a worker can operate the backhoe BH in a safe and stable manner without directly exposing his or her body to the environment (note that the backhoe BH may be an autonomously-operated robot, or may be remotely operated even when the driver's seat 122A is provided. Of course, no driver's seat may be provided.). The arm body 123 swingable up and down is attached to the revolving body 122.

As shown in FIG. 5, the armbody 123 includes: a boom 124 attached to the revolving body 122; and an arm 125 attached to a leading end of the boom 124. The arm 125 is swingable by a cylinder mechanism 124A. The grapple 127 for grasping the constituent 103A is attached to a leading end of the arm 125. The grapple 127 is configured to include a turning mechanism 128 so that grasping parts 129 become turnable, and configured to be swingable by a cylinder mechanism 125A via a link mechanism 126. That is, the grapple 127 of the backhoe BH can grasp a constituent 103A and can move the constituent 103A up, down, right, and left by being swingably attached to a leading end of the arm body 123. The grapple 127 is configured to be capable of grasping a constituent 103A on the steel conveyor belt 106 and moving the constituent 103A to the yard 108. Note that the grasping mechanism of the backhoe BH may not necessarily be the grapple 127. The backhoe BH may include a suction mechanism instead of the grasping mechanism.

The fluid spraying mechanism RH will be described next with reference to FIGS. 1, 2A, 2B, and 4.

The fluid spraying mechanism RH is provided to prevent the spread of dust and bad odor generated when the constituents 103A of the wastes 103 are moved or crushed. The generation of such dust can be reduced by wetting the constituents 103A. The smell, however, can hardly be reduced simply by wetting the constituents since the smell comes from fine particles diffused in the air. Moreover, the fine particles of the smell are often smaller than the dust, and thus are more likely to spread over a larger area. Therefore, the use of a deodorizer having an effect to get rid of the smell or a fragrance for adding another scent to make the smell unperceivable also produces some effect. In terms of deodorization, however, physically making the diffusion of the fine particles shut off from the ambient air using the foam BL is extremely effective. That is, the fluid spraying mechanism RH in the present embodiment is configured to spray the foam BL wherever possible.

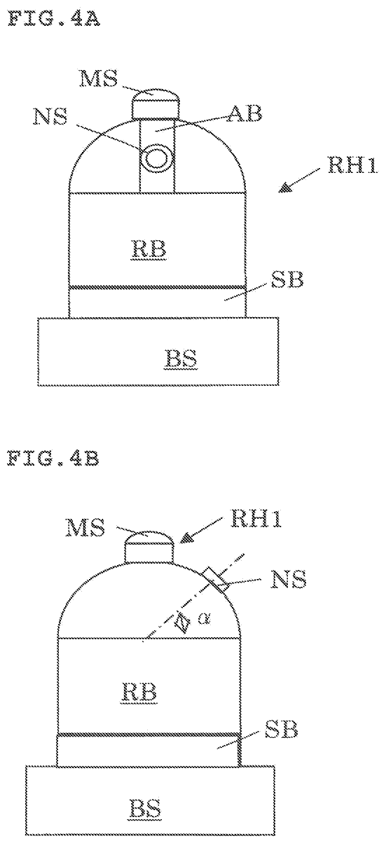

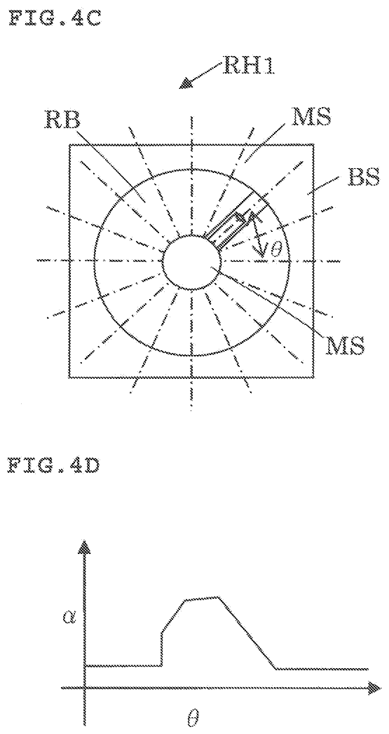

As shown in FIG. 1, the fluid spraying mechanism RH is constituted of the one or more fluid spraying machines RH1 to RH7. The fluid spraying mechanism RH is capable of spraying the foam BL or the liquid DL to the surfaces of the constituents 103A on the steel conveyor belt 106. As shown in FIG. 1, the fluid spraying mechanism RH includes the fluid spraying machines RH1 and RH2 (the first spraying part) for spraying the foam BL upstream of the backhoe BH1 in the steel conveyor belt 106. The fluid spraying machines RH1 to RH7 each have the same configuration, and thus the configuration will be described taking the fluid spraying machine RH1 shown in FIGS. 4A to 4C as an example.

The fluid spraying machine RH1 includes: a support member SB; a rotating member RB rotatably supported by the support member SB; a tilt member AB supported by the rotating member RB so as to be capable of tilting upwardly and downwardly; and a nozzle NS supported by the tilt member AB. Abase BS is further disposed under the support member SB of the fluid spraying machine RH1. A recognition sensor MS is provided above the rotating member RB. The base BS is provided to adjust the height of the fluid spraying machine RH1 and to stabilize the disposition of the fluid spraying machine RH1. The recognition sensor MS is provided to locate a place at which the grapple 127 comes into contact with a constituent 103A in order to prevent the spread of dust or smell possibly generated when the constituent 103A undergoes change in state.

The rotating member RB supports: a rotating device (not shown) for turning the rotating member RB with respect to the support member SB; a tilting device (not shown) for tilting the tilt member AB with respect to the rotating member RB; and an opening and closing device for regulating the discharge of the foam BL or the liquid DL from the nozzle NS, for example. A control device (not shown) for controlling the rotating device, the tilting device, and the opening and closing device, as well as a radio unit for externally controlling the control device are also supported by the rotating member RB.

Note that the control device can automatically determine a rotation angle θ of the nozzle NS on the basis of an output of the recognition sensor MS. The recognition sensor MS includes a fish-eye lens, for example, and can output a 360-degree image therearound. Thus, once the shape of the grapple 127 in the backhoe BH is recognized by processing the image output of the recognition sensor MS by the control device, for example, the position of the grapple 127 can be identified in the recognition sensor MS. Thus, the control device can set the rotation angle θ of the nozzle NS so as to align with the direction of the grapple 127 as shown in FIG. 4C.

Up to a certain angular range, a sprayed region of the foam BL or the liquid DL increases as a tilt angle α of the nozzle NS increases. Utilizing such a characteristic, the tilt angle α in the present embodiment is determined for each rotation angle θ at the timing when places where the fluid spraying machines RH1 to RH7 are disposed are determined as shown in FIG. 4D. For example, the tilt angle α is made smaller if the foam BL or the liquid DL is sprayed to a closer region. The tilt angle α is made larger if the foam BL or the liquid DL is sprayed to a larger region.

The shape of the nozzle NS differs between when the foam BL is sprayed from the nozzle NS and when the liquid DL is sprayed therefrom. Thus, the shape of the nozzle NS is selected and changed in advance when the fluid spraying machines RH1 to RH7 are placed.

Emission regions of the fluid spraying machines RH1 to RH7 will be described next with reference to FIG. 1.

First, the fluid spraying machines RH1 and RH2 are disposed in the vicinity of the vibrating screening machine VS and in portions of the guide walls 107 on the sides of the steel conveyor belt 106. The fluid spraying machines RH1 and RH2 spray the foam BL to the wastes 103 on the vibrating screening machine VS as well as on the steel conveyor belt 106 upstream of the backhoe BH1. That is, the fluid spraying machines RH1 and RH2 correspond to the first spraying part and a fourth spraying part as well. The fluid spraying machines RH1 and RH2 are disposed at positions opposed to each other with the steel conveyor belt 106 interposed therebetween. Note that the foam BL contains a deodorizer.

The fluid spraying machine (second spraying part) RH3 is disposed in a portion of the guide wall 107 on a side of the steel conveyor belt 106. The fluid spraying machine RH3 is disposed downstream of the fluid spraying machines RH1 and RH2 in the steel conveyor belt 106. The fluid spraying machine RH3 sprays the liquid DL to the wastes 103 on the steel conveyor belt 106 in accordance with the movements of the grapples 127 of the backhoes BH1 and BH2. The liquid DL in this case contains a fragrance. That is, the fluid spraying machine RH3 sprays the liquid DL unlike the foam BL sprayed by the fluid spraying machines RH1 and RH2. The fluid spraying machine RH3 is provided in the vicinity of the backhoes BH1 and BH2 and configured to spray the liquid DL to the constituents 103A which the backhoes BH1 and BH2 come into contact with. Note that the foam BL sprayed by the fluid spraying machines RH1 and RH2 partially disappears by this liquid DL. Thus, the constituents 103A can be efficiently grasped by the grapples 127 of the backhoes BH1 and BH2.

The fluid spraying machine RH4 (third spraying part) is provided in a portion of the guide wall 107 that is away from the steel conveyor belt 106. The fluid spraying machine RH4 sprays the foam BL to the non-combustible bulky article placement part 108B, the home appliance placement part 108C, the asphalt concrete placement part 108D, and the fishing net placement part 108E at regular time intervals regardless of the movements of the grapples 127. Note that the foam BL contains a fragrance.

The fluid spraying machine RH5 is disposed in a portion of the guide wall 107 on the side of the steel conveyor belt 106. The fluid spraying machine RH5 is disposed downstream of the fluid spraying machines RH1 and RH2 in the steel conveyor belt 106. The fluid spraying machine RH5 sprays the liquid DL to the wastes 103 on the steel conveyor belt 106 in accordance with the movements of the grapples 127 of the backhoes BH3 and BH4. The liquid DL in this case also contains a fragrance. That is, the fluid spraying machine RH5 sprays the liquid DL unlike the foam BL sprayed by the fluid spraying machines RH1 and RH2. The fluid spraying machine RH5 is provided in the vicinity of the backhoes BH3 and BH4 and configured to spray the liquid DL to the constituents 103A which the backhoes BH3 and BH4 come into contact with. Note that the foam BL sprayed by the fluid spraying machines RH1 and RH2 partially disappears by this liquid DL. Thus, the fluid spraying machine RH5 also corresponds to the second spraying part as with the fluid spraying machine RH3.

The fluid spraying machine RH6 is provided at a position away from the steel conveyor belt 106. The fluid spraying machine RH6 sprays the foam BL to the scrap metal placement part 108F, the dangerous article placement part 108G, and the wood piece placement part 108I at regular time intervals regardless of the movements of the grapples 127 and the handling mechanism 140. Note that the foam BL also contains a fragrance. Thus, the fluid spraying machine RH6 also corresponds to the third spraying part as with the fluid spraying machine RH4.

The fluid spraying machine RH7 is provided at a position away from the steel conveyor belt 106. The fluid spraying machine RH7 sprays the foam BL to the hazardous article placement part 108H and the residue placement part 110 at regular time intervals regardless of the movements of the grapple 127 and the handling mechanism 140. Note that the foam BL also contains a fragrance. Thus, the fluid spraying machine RH7 also corresponds to the third spraying part as with the fluid spraying machines RH4 and RH6.

Note that a pump part for causing the nozzle NS to spray the foam BL or the liquid DL is separately connected to each of the fluid spraying machines RH1 to RH7. For example, a common pump part is connected to the fluid spraying machines RH1 and RH2, and an aqueous solution containing a deodorizer and a surface-active agent is supplied thereby. Moreover, a common pump part is connected to the fluid spraying machines RH3 and RH5, and an aqueous solution containing a fragrance is supplied thereby. Furthermore, a common pump part is connected to the fluid spraying machines RH4, RH6, and RH7, and an aqueous solution containing a fragrance and a surface-active agent is supplied thereby.

The recognition device 134, the processing part 137, and the handling mechanism 140 will be described next with reference to FIGS. 2B, 6A, 6B, and 7.

As shown in FIG. 7, the recognition device 134 includes an irradiation part 135 for irradiating the wastes 103 on the steel conveyor belt 106 with light, and a light receiving part 136 that receives light polarized by the wastes 103. In the present embodiment, the surface of the steel conveyor belt 106 is illuminated by (irradiated with) visible light (such as a plurality of patterned rays of light) of light, for example, from the irradiation part 135 such as a fluorescent lamp, an LED, or a projector. The visible light reflected (polarized) by the wastes 103 is captured by a camera, which is the light receiving part 136. That is, the camera takes an image of the wastes 103, detects the reflection intensity pattern, color, etc. of the visible light, and produces an output that enables the position, shape, and size of the piece of wood 103AA to be determined.

As shown in FIG. 7, the processing part 137 is connected to the irradiation part 135 and the light receiving part 136. The processing part 137 identifies the position, shape, and size of the piece of wood 103AA from among the wastes 103 on the basis of the output of the light receiving part 136 (in other words, the recognition device 134 produces an output that enables the piece of wood 103AA on the steel conveyor belt 106 to be identified). The processing part 137 obtains the position of the center of gravity in the piece of wood 103AA on the basis of the output of the recognition device 134. The processing part 137 also controls the on and off operations of the irradiation part 135, the intensity of the visible light irradiated from the irradiation part 135, etc. The processing part 137 is also connected to the handling mechanism 140, and can control the handling mechanism 140 so as to remove the piece of wood 103AA from the steel conveyor belt 106 by causing a holding part 146 to hold the piece of wood 103AA at the obtained position of the center of gravity. The processing part 137 is also connected to a speed detection part (encoder) 106A of the steel conveyor belt 106. Consequently, the feed speed of the steel conveyor belt 106 is directly measured and processed by the processing part 137 (the feed speed of the steel conveyor belt 106 may be calculated from the signal of the recognition device 134 without using the encoder). Note that the hollow arrow in FIG. 7 represents the feeding direction of the steel conveyor belt 106 (the conveying direction of the wastes 103). The processing part 137 controls the handling mechanism 140 in consideration of the feed speed of the steel conveyor belt 106. The processing part 137 may be integral with the frame body 130, or may be disposed in the vicinity of the frame body 130.

As shown in FIG. 6A, the handling mechanism 140 includes: the holding part 146 capable of holding and releasing the piece of wood 103AA on the steel conveyor belt 106; and the articulated arm mechanism that includes a plurality of links (arm parts) 142 and 144 each capable of turning and supports the holding part 146. The articulated arm mechanism is supported by the support shaft 138 (which is a part of the articulated arm mechanism) and configured to be turnable about the support shaft 138. Specifically, the articulated arm mechanism includes: the first link 142 supported by the support shaft 138 via a first articulation 141; the second link 144 supported by the first link 142 via a second articulation 143; and the holding part (hand) 146 supported by the second link 144 via a third articulation 145. The holding part 146 includes two hand members, for example, and one of the hand members can relatively move closer to or away from the other one of the hand members. That is, opposed surfaces of the two hand members can be used to pinch (clamp) the piece of wood 103AA. Each of the first articulation 141 to the third articulation 145 includes a driving source allowing for biaxial turning. The maximum range of motion for the holding part 146 of the handling mechanism 140 gets across the guide walls 107. Thus, when the handling mechanism 140 holds the piece of wood 103AA, the piece of wood 103AA can be placed on the wood piece placement part 108I provided on an outer side of the guide wall 107. Although not illustrated in the figure, a sensor for detecting force may be provided in the holding part 146 in order to determine whether the piece of wood 103AA is held reliably by the handling mechanism 140. Note that a solid-line circle within the frame body 130 in FIGS. 1 and 6B represents a maximum range reached by the holding part 146 of the handling mechanism 140, and the holding part 146 is configured so as not to reach the struts 131.

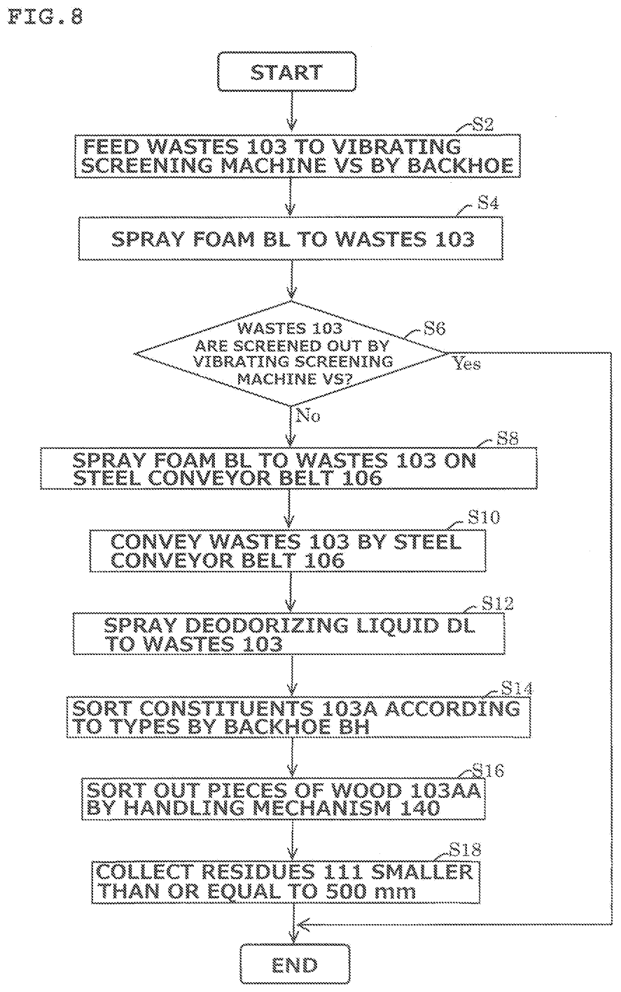

A sorting procedure in the waste sorting facility 100 will be described next mainly with reference to FIG. 8.

First, a truck (not shown) loaded with the wastes 103 is moved to the waste feeding part 102. There after, the wastes 103 on a loading platform of the truck are dumped once (at this time, the foam BL may be sprayed to the wastes 103 with a fluid spraying machine). The constituents 103A of the dumped wastes 103 are then grasped by a backhoe (not shown) and fed to the vibrating screening machine VS (step S2 in FIG. 8). Note that the wastes 103 may be fed directly to the slant plane SP of the vibrating screening machine VS from the loading platform by tilting the loading platform of the truck.

Subsequently, the foam BL is sprayed to the wastes 103 with the fluid spraying machines RH1 and RH2 (step S4 in FIG. 8).

Subsequently, constituents 103A of the fed wastes 103 having sizes smaller than or equal to the predetermined reference size are screened out by the vibrating screening machine VS (Yes in step S6 of FIG. 8). The screened out wastes 103 are collected as the residues 111 at the discharge outlet AO.

Constituents 103A of the fed wastes 103 having sizes larger than the predetermined reference size move along the slant plane SP without being screened out by the vibrating screening machine VS (No in step S6 of FIG. 8), and are placed on the steel conveyor belt 106. Also at this time, the foam BL is sprayed to the wastes 103 on the steel conveyor belt 106 by the fluid spraying machines RH1 and RH2 (step S8 in FIG. 8). Specifically, the wastes 103 remaining without being screened out are flattened by the slant plane SP of the vibrating screening machine VS and fed onto the steel conveyor belt 106 from a lower end of the slant plane SP. In the present embodiment, the spraying of the foam BL from the fluid spraying machines RH1 and RH2 continues from step S4 to step S8 in FIG. 8.

Subsequently, the wastes 103 with the foam BL attached thereto are conveyed by the steel conveyor belt 106 (step S10 in FIG. 8).

Subsequently, the liquid DL containing a fragrance is sprayed to the positions of the grapples 127 of the backhoes BH1 and BH2 (BH3 and BH4) by the fluid spraying machine RH3 (RH5) (step S12 in FIG. 8).

The foam BL on the constituents 103A in the vicinity of th grapples 127 disappears by the spraying of the liquid DL, and the constituents 103A are then sorted according to the types (according to the items) from among the wastes 103 by the backhoes BH1 and BH2 (BH3 and BH4) (step S14 in FIG. 8). Specifically, the four backhoes BH1 to BH4, which are disposed in the conveying direction (x direction) of the wastes 103 so as to face the steel conveyor belt 106, grasp constituents 103A assigned thereto from among the wastes 103 being conveyed by the steel conveyor belt 106, and remove the constituents 103A from the steel conveyor belt 106. Subsequently, the four backhoes BH1 to BH4 place the constituents 103A assigned thereto on the corresponding placement parts 108A to 108H separated according to the types. At the timing when the four backhoes BH1 to BH4 start to place the constituents 103A assigned thereto, the fluid spraying machines RH4 and RH6 start to spray the foam BL to the placement parts 108B to 108G. The timing to start such spraying may be automatically synchronized with the moment when the steel conveyor belt 106 starts to operate.

Subsequently, the processing part 137 identifies a piece of wood 103AA from among the wastes 103 having passed the backhoe BH4 on the basis of an output of the recognition device 134. That is, the wastes 103 having passed the backhoe BH4 are irradiated with visible light by the irradiation part 135 of the recognition device 134, the reflected light is received by the light receiving part 136, and the light receiving part 136 outputs information on the reflected light. That is, the recognition device 134 produces an output that enables a piece of wood 103AA to be identified from among the wastes 103 being conveyed. The processing part 137 then determines the position and size of the piece of wood 103AA on the basis of the output of the recognition device 134.

Subsequently, the processing part 137 controls the position of the holding part 146 of the handling mechanism 140 in consideration of the feed speed of the steel conveyor belt 106. The handling mechanism 140 then holds the determined piece of wood 103AA, and removes it from the steel conveyor belt 106 (step S16 in FIG. 8). The handling mechanism 140 places the removed piece of wood 103AA onto the wood piece placement part 108I. Note that the fluid spraying machine RH6 starts to spray the foam BL to the wood piece placement part 108I and the fluid spraying machine RH7 starts to spray the foam BL to the residue placement part 110 at the timing when the handling mechanism 140 starts to place the piece of wood 103AA assigned thereto onto the wood piece placement part 108I.

The remaining wastes 103, e.g., the residues 111 smaller than or equal to 500 mm, are further screened out by a vibrating screening machine (not shown) in the residue placement part 110, and collected (step S18 in FIG. 8). For example, residues 111 smaller than or equal to several tens of millimeters are screened out by the vibrating screening machine, and thus those remaining without being screened out are residues 111 smaller than or equal to 500 mm and larger than several tens of millimeters. At this time, the foam BL sprayed by the fluid spraying machine RH7 is sprayed to the residues 111. These residues 111 are carried to a predetermined place by a truck, and conveyed to a predetermined treatment site where a final sorting step or a crushing step is further performed (the residues may be buried). Note that the constituents 103A placed on the yards 108 are collected and conveyed to predetermined treatment sites when appropriate.

As described above, the fluid spraying machines RH1 and RH2 in the present embodiment spray the foam BL to the constituents 103A of the wastes 103 upstream of the backhoe BH1 disposed on the most upstream side in the steel conveyor belt 106. Thus, dust or smell can be prevented from spreading from the steel conveyor belt 106 before sorting with the backhoe BH1 is performed. According to the present embodiment, especially by using the foam BL without using much water, the risk of being flooded can be reduced. Dust can be visually recognized easily, and thus measures against dust can be taken easily. Bad odor, however, is extremely difficult to be visually recognized, and smell is more likely to spread over a larger area as compared to dust. In order to get rid of the smell with the liquid DL such as water, a large amount of liquid DL is required for washing away the source of the smell completely. Thus, using the foam BL as in the present embodiment can be regarded as an extremely effective method. Being able to cut off the smell as in the present embodiment can significantly reduce influence on the surrounding environment. Furthermore, the spread of the smell can be further suppressed by the inclusion of a deodorizer in the foam BL.

Without being limited to the foregoing, the liquid DL may be sprayed to the constituents 103A of the wastes 103 upstream of the backhoe BH1 instead of the foam BL. When the liquid DL is plain water containing no deodorizer or fragrance, at least the spread of dust can be reduced. When the liquid DL further contains a deodorizer or a fragrance, unpleasantness caused by the smell or a load on the surrounding environment can be reduced accordingly. At the same time, the configuration of the fluid spraying machines RH1 and RH2 can be simplified, and the sprayed range can be easily enlarged. Alternatively, the foam BL may only contain a mere surface-active agent without containing a deodorizer, or may contain a fragrance.

In the present embodiment, the foam BL is sprayed to the fed wastes 103 by the two fluid spraying machines RH1 and RH2 from both sides of the steel conveyor belt 106 and in a symmetrical manner. Thus, the surface of the wastes 103 can be sufficiently covered with the foam BL as compared to when the foam BL is sprayed from one side, and this makes it possible to reduce the spread of dust and smell more. Without being limited to the foregoing, only one fluid spraying machine may be provided. In such a case, the cost of the waste sorting facility can be reduced accordingly. At the same time, finding a place to dispose the fluid spraying machine becomes easier, and a degree of flexibility for the layout of the waste sorting facility can be increased. Moreover, risk of mistakenly breaking the fluid spraying machine by a backhoe can be reduced.

In the present embodiment, the liquid DL is sprayed to the constituents 103A, which the grapples 127 of the backhoes BH1 to BH4 come into contact with, by the fluid spraying machines RH3 and RH5 in the vicinity of the backhoes BH1 to BH4. Thus, when sorting is performed by the backhoes BH1 to BH4, the spread of dust or smell caused by changes in the states of the constituents 103A can be reduced. At the same time, the foam BL sprayed by the fluid spraying machines RH1 and RH2 can be made disappear speedily by spraying the liquid DL when sorting is performed by the backhoes BH1 to BH4. Consequently, being unable to surely recognize the constituents 103A visually due to the foam BL can be prevented from occurring, and the constituents 103A can be sorted in a more stable manner. Moreover, since the fluid spraying machines RH3 and RH5 spray the liquid DL locally, an amount of water sprayed by the fluid spraying machines RH3 and RH5 can be reduced. Thus, risk of flooding the steel conveyor belt 106 and its surrounding region can be reduced. Furthermore, since the foam BL sprayed by the fluid spraying machines RH1 and RH2 contains a deodorizer, the smell of the constituents 103A before being sprayed with the liquid DL by the fluid spraying machines RH3 and RH5 has been mitigated. Thus, as compared to when the liquid DL is directly sprayed to the constituents 103A to which no deodorizer has been applied, possibility to create more unpleasant smell due to the fragrance contained in the liquid DL can be reduced in the present embodiment.

Without being limited to the foregoing, the foam BL may further be sprayed also in the vicinity of the backhoes BH1 to BH4. The visibility of the constituents can be kept from largely deteriorating by spraying the foam BL lightly, and such additional use of the foam BL can reduce the spread of smell more reliably. Alternatively, contained in the liquid DL may be a deodorizer, or the liquid DL may be plain water. Of course, no liquid DL or no foam BL may be sprayed in the vicinity of the backhoes BH1 to BH4 without providing the fluid spraying machines RH3 and RH5.

In the present embodiment, the fluid spraying machines RH4, RH6, and RH7 spray the foam BL to the placement parts 108B to 108I and 110 excluding the combustible bulky article placement part 108A. Thus, even if dust or smell from the constituents 103A is spread again upon or after the placement of the constituents 103A on the placement parts 108B to 108I and 110, the spread of such dust or small can be reduced. Furthermore, since the form BL is sprayed from the fluid spraying machines RH4, RH6, and RH7, risk of flooding the placement parts 108B to 108I and 110 can be reduced. Without being limited to the foregoing, the liquid DL may be sprayed to the placement parts 108B to 108I and 110 instead of the foam BL, or no spraying may be performed. Of course, the foam BL or the liquid DL may be sprayed to all of the placement parts 108A to 108I and 110 including the combustible bulky article placement part 108A. Also in this case, the foam BL or the liquid DL may or may not contain a fragrance or a deodorizer.

In the present embodiment, the constituents 103A are grasped and placed on the placement parts 108A to 108H by the four backhoes BH1 to BH4. Thus, even if the positions and sizes of the constituents 103A to be sorted are non-uniform, the backhoes BH1 to BH4 can adjust their positions in accordance with the sizes, positions, and moving speed of many constituents 103A and can optimize the positions of the grapples 127. That is, many constituents 103A can be efficiently grasped and sorted in the present embodiment. Without being limited to the foregoing, it is only necessary to provide at least one or more backhoes BH, and it is only necessary to provide a first working machine capable of grasping and sorting the constituents 103A. Of course, no backhoe BH may be provided as long as the handling mechanism 140 is provided.

In the present embodiment, the vibrating screening machine VS is provided at the preceding stage of the steel conveyor belt 106. Thus, the wastes 103 to be placed on the steel conveyor belt 106 can be reduced in volume and flattened by the vibrating screening machine VS. This enables the constituents 103A on the steel conveyor belt 106 to be sorted easily by the backhoes BH1 to BH4 and the handling mechanism 140. Without being limited to the foregoing, no vibrating screening machine VS may be provided.

In the present embodiment, there is provided the backhoe BH that includes the grapple 127, grasps the wastes 103 by the grapple 127, and feeds the wastes 103 to the vibrating screening machine VS. This can reduce limitations on the size and position of the vibrating screening machine VS, and an appropriate vibrating screening machine VS can thus be employed. At the same time, the wastes 103 can be easily transferred onto the vibrating screening machine VS. The wastes 103 can be fed to the vibrating screening machine VS according to the capacity of the vibrating screening machine VS. Furthermore, since constituents 103A unsuitable for being sorted by the vibrating screening machine VS, the backhoes BH1 to BH4, and the handling mechanism 140 can be sorted out in advance, the wastes 103 fed to the vibrating screening machine VS can be efficiently sorted. Without being limited to the foregoing, the wastes 103 may be directly dumped to the vibrating screening machine VS by a truck, for example.

In the present embodiment, the foam BL is sprayed also to the wastes 103 fed to the vibrating screening machine VS by the fluid spraying machines RH1 and RH2. Thus, dust and bad odor generated by the vibrations of the vibrating screening machine VS can be efficiently reduced. At the same time, the need to provide a fluid spraying machine separately from the fluid spraying machines RH1 and RH2 for the vibrating screening machine VS can be eliminated, and thus its cost and a place to dispose such a fluid spraying machine can be cut accordingly. Without being limited to the foregoing, another fluid spraying machine different from the fluid spraying machines RH1 and RH2 may be provided for the vibrating screening machine VS. Alternatively, no spraying may be performed to the wastes 103 on the vibrating screening machine VS. In such a case, possibility to slow down the processing speed of the vibrating screening machine VS by the spraying of the foam BL can be reduced, and speedier processing can be thus achieved. Of course, the liquid DL may be sprayed to the wastes 103 on the vibrating screening machine VS, a fragrance may be contained, or plain water may be sprayed to the wastes on the vibrating screening machine VS.

In the present embodiment, the processing part 137 identifies a piece of wood 103AA on the basis of an output of the recognition device 134, and controls the handling mechanism 140 so as to remove the identified piece of wood 103AA from the steel conveyor belt 106. Thus, the need for manual sorting of the wastes 103 directly performed by a worker can be eliminated while achieving even the sorting out operation of the piece of wood 103AA, i.e., a substantial final sorting step. Even if the wastes 103 contain those (materials and shapes) having risk to harm the human body such as hazardous, toxic, or dangerous substances including radioactive materials and ultrafine particle dust, for example, or even if an area in which the sorting needs to be performed is affected by radioactive materials or ultrafine particle dust, for example, the human body can be kept from being directly exposed to the environment.

In the present embodiment, the one or more backhoes BH can grasp a constituent 103A of the wastes 103 not to be removed by the handling mechanism 140 and larger than the sizes of the pieces of wood 103AA to be removed by the handling mechanism 140, and remove such a constituent 103A from the steel conveyor belt 106. This can eliminate the need to enhance the performance of, or complicate, the recognition device 134 to detect pieces of wood 103AA possibly hidden by large constituents 103A. Thus, an increase in the cost of the recognition device 134 can be avoided. At the same time, since the piece of wood 103AA can be prevented from being hidden by a large constituent 103A, the sorting efficiency of the handling mechanism 140 can also be improved.

In the present embodiment, the handling mechanism 140 is used to remove the pieces of wood 103AA. Thus, the wastes 103 including many pieces of wood 103AA can be largely reduced in volume, and the removed pieces of wood 103AA can be readily utilized for wooden chips of a biomass boiler or for incineration. Without being limited to the foregoing, the handling mechanism 140 (and the processing part 137) may not be provided as long as one or more backhoes BH are provided. Alternatively, constituents removed by the handling mechanism 140 may include not only pieces of wood but also another constituent. Of course, the constituent removed by the handling mechanism may be a constituent other than a piece of wood.

The present embodiment can thus reduce the load of the waste sorting facility 100 on the surrounding environment.

Although the present invention has been described with reference to the first embodiment, the present invention is not limited to the first embodiment. That is, modifications and alterations in design are obviously possible without departing from the scope of the present invention.

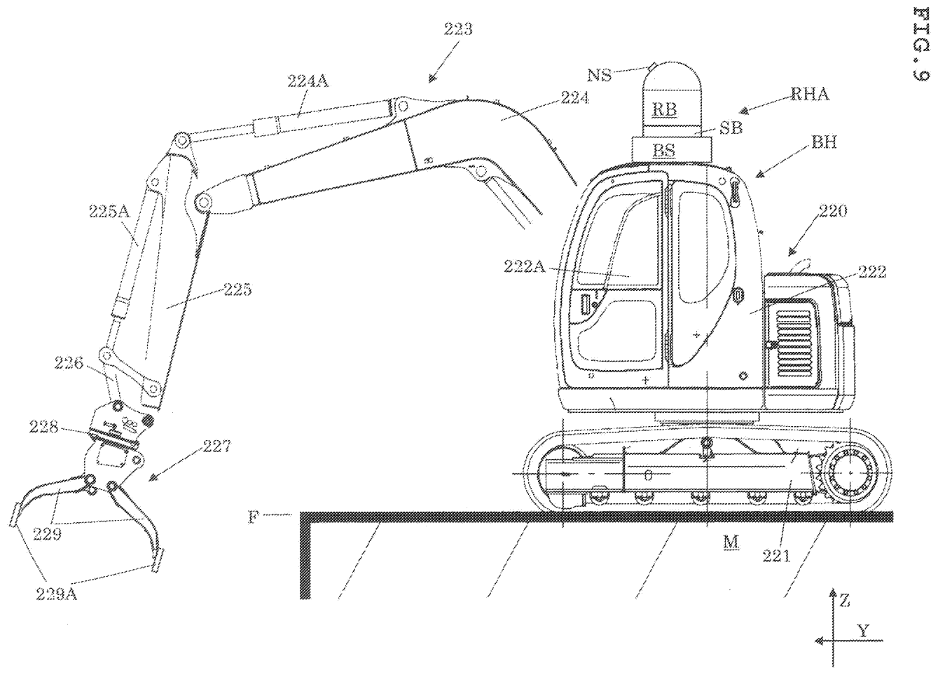

For example, the fluid spraying machines RH3 and RH5 for spraying the liquid DL to the constituents 103A which the grapples 127 of the backhoes BH1 to BH4 come into contact with are attached to the guide walls 107 in the first embodiment. The present invention, however, is not limited thereto. As shown in FIG. 9 illustrating a second embodiment, a fluid spraying machine (second spraying part) RHA may be provided in backhoes (first working machines) BH1 to BH4. The second embodiment is different from the first embodiment only in the backhoe BH and the fluid spraying machine RHA corresponding to the second spraying part. Thus, a description on the other elements will be omitted, and the same reference signs as those in the first embodiment will be used for description unless changes have been made.

In the second embodiment, the fluid spraying machine RHA is disposed on a revolving body 222 of the backhoe BH, for example, as shown in FIG. 9. Thus, when each backhoe BH includes the fluid spraying machine RHA, a rotating member RB needs not be rotated. Moreover, since the height of a steel conveyor belt 106 is constant, a tilt member AB also needs not be tilted. This makes it easy to adjust a region to be sprayed by the fluid spraying machine RHA (even if only one of two backhoes BH is equipped with the fluid spraying machine RHA without providing the fluid spraying machine RHA in each backhoe BH, the range of rotation angle θ of the rotating member RB can be reduced, and the control of the fluid spraying machine RHA can be simplified accordingly). At the same time, the occurrence of a collision of the backhoe BH, for example, can be reduced, the risk of breaking or deformation by the fluid spraying machine RHA can be reduced, and difficulty to find a space to dispose the fluid spraying machine RHA can be eliminated.

In the second embodiment, a blade plate 229A is further provided in each of leading ends of grasping parts 229 of a grapple 227. The pair of blade plates 229A are configured so that the leading ends thereof come into contact with each other when the grasping parts 229 are brought closest to each other. This makes it possible to sort out even a finer constituent 103A by the backhoe BH. Thus, no handling mechanism 140 may be provided also in the second embodiment.

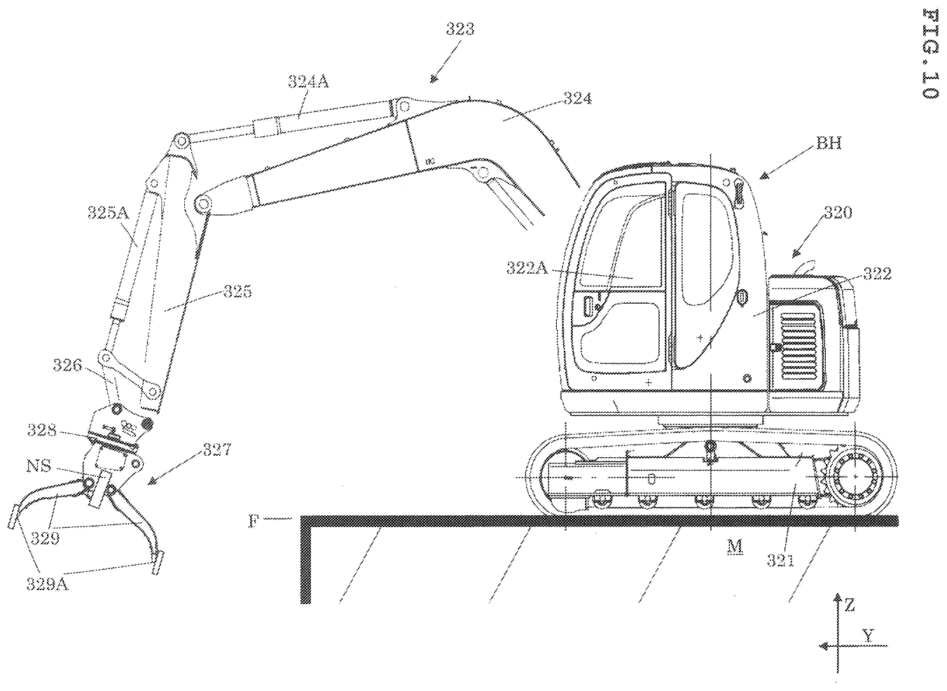

Although the fluid spraying machine RHA is just disposed on the revolving body 222 of the backhoe BH in the second embodiment, the present invention is not limited thereto. The fluid spraying machine may be configured as shown in FIG. 10 illustrating a third embodiment. Since only a backhoe BH and a fluid spraying machine RHA corresponding to a second spraying part are different, a description on the other elements will be omitted. The same reference signs as those in the first embodiment will be used for description unless changes have been made.

In the third embodiment, the fluid spraying machine may be integral with the backhoe BH, for example, as shown in FIG. 10. A nozzle NS is provided in a grapple 327. Thus, the need to provide a space for the fluid spraying machine can be eliminated, and liquid DL can be easily and reliably sprayed to a constituent 103A, which the grapple 327 comes into contact with, without controlling the position of the nozzle NS. Note that an on-off valve for controlling a discharge amount of the liquid DL can be provided in the grapple 327 or on a revolving body 322. In the present embodiment, blade plates 329A are provided at leading ends of grasping parts 329 as with FIG. 9. This makes it possible to sort out even a finer constituent 103A as with the second embodiment.

It is also assumed in the first embodiment that the wastes 103 are fed to the vibrating screening machine VS with the backhoe (second working machine) BH. Thus, the backhoe BH shown in FIG. 9 or 10 may be used in the present invention as such a backhoe BH for feeding the wastes 103 to the vibrating screening machine VS. In such a case, since the foam BL or the liquid DL can be efficiently sprayed to the wastes 103 before feeding the wastes 103 to the vibrating screening machine VS, the spread of dust or bad odor can be further reduced.

Although the steel conveyor belt is used as a conveying unit to convey the wastes in the above-described embodiments, the present invention is not limited thereto. For example, the vibrating screening machine VS may be used as a conveying unit without using the steel conveyor belt, and the recognition device, the handling mechanism, etc. may be disposed with respect to the slant plane SP.

Although the foam BL is sprayed to the wastes 103 from above by the fluid spraying machine in the above-described embodiments, the present invention is not limited thereto. For example, the foam BL may be sprayed onto the vibrating screening machine VS and onto the steel conveyor belt, or only onto the steel conveyor belt before the wastes 103 are placed thereon. In such a case, the wastes 103 are interposed between the layers of the foam BL from their top and bottom, thus making it possible to prevent the generation of dust and bad odor more. Note that the fluid spraying machine (fourth spraying part) in this case may be the fluid spraying machines RH1 and RH2, or another fluid spraying machine. Furthermore, the fluid spraying machine may be incorporated into the vibrating screening machine VS or the steel conveyor belt.

### INDUSTRIAL APPLICABILITY

The present invention can be widely applied to sorting of wastes.

### REFERENCE SIGNS LIST

100 . . . waste sorting facility
102 . . . waste feeding part
103 . . . wastes
103A, . . . constituent
103AA . . . piece of wood
104 . . . working machine disposition part
106 . . . steel conveyor belt
106A . . . speed detection part (encoder)
107 . . . guide wall
108 . . . yard
108A . . . combustible bulky article placement part
108B . . . non-combustible bulky article placement part
108C . . . home appliance placement part
108D . . . asphalt concrete placement part
108E . . . fishing net placement part
108F . . . scrap metal placement part
108G . . . dangerous article placement part
108H . . . hazardous article placement part
108I . . . wood piece placement part
110 . . . residue placement part
111 . . . residue
120, 220, 320 . . . vehicle body
121, 221, 321 . . . traveling body
122, 222, 322 . . . revolving body
122A, 222A, 322A . . . driver's seat
123, 223, 323 . . . arm body
124, 224, 324 . . . boom
124A, 125A, 224A, 225A, 324A, 325A . . . cylinder mechanism
125, 225, 325 . . . arm
126, 226, 326 . . . link mechanism
127, 227, 327 . . . grapple
128, 228, 328 . . . turning mechanism
129, 229, 329 . . . grasping part
130 . . . frame body
131 . . . strut
132 . . . upper frame
133 . . . extended frame
134 . . . recognition device
135 . . . irradiation part
136 . . . light receiving part
137 . . . processing part
138 . . . support shaft
140 . . . handling mechanism
141, 143, 145 . . . articulation
142, 144 . . . link
146 . . . holding part
229A, 329A . . . blade plate
AB . . . tilt member
AO . . . discharge outlet
BH, BH1 to BH4 . . . backhoe
BS . . . base
F, G . . . level
M . . . mound
MS . . . recognition sensor
MT . . . geared motor
NS . . . nozzle
RB . . . rotating member
RH . . . fluid spraying mechanism
RH1 to RH7, RHA . . . fluid spraying machine
SB . . . support member
SP . . . slant plane
VS . . . vibrating screening machine
α, θ . . . angle

1. A waste sorting facility for sorting wastes, comprising:
a conveying unit that conveys the wastes;
one or more first working machines disposed in a conveying direction of the wastes so as to face the conveying unit and capable of removing a constituent that constitutes the wastes from the conveying unit;
one or more constituent placement parts on which the constituent removed from the conveying unit by the one or more first working machines is placed, the one or more constituent placement parts being disposed so as to face the conveying unit; and
a fluid spraying mechanism capable of spraying foam or liquid to a surface of the constituent on the conveying unit, wherein
the fluid spraying mechanism includes a first spraying part that sprays the foam or the liquid upstream of the one or more first working machines in the conveying unit and a second spraying part that sprays the foam or the liquid downstream of the first spraying part in the conveying unit and in the vicinity of the one or more first working machines, and
the first spraying part sprays the foam and the second spraying part sprays the liquid to the constituent which the first working machine comes into contact with.

2. (canceled)

3. The waste sorting facility according to claim 1, wherein
the second spraying part is provided to the first working machine.

4. (canceled)

5. The waste sorting facility according to claim 1, further comprising a third spraying part that sprays the foam or the liquid in the one or more constituent placement parts.

6. The waste sorting facility according to claim 1, wherein
the foam or the liquid contains any of a deodorizer and a fragrance.

7. The waste sorting facility according to claim 1, wherein
the first working machine includes: a traveling body; a revolving body rotatable with respect to the traveling body; an arm body attached to the revolving body so as to be swingable up and down; and a grasping mechanism capable of grasping the constituent and moving the constituent up, down, right, and left by being swingably attached to a leading end of the arm body.

8. The waste sorting facility according to claim 1, comprising a screening unit that screens out the constituent of the wastes having a size smaller than or equal to a predetermined reference size at a preceding stage of the conveying unit.

9. The waste sorting facility according to claim 8, wherein
the fluid spraying mechanism includes a fourth spraying part that sprays the foam or the liquid to the wastes on the screening unit.

10. The waste sorting facility according to claim 8, comprising a second working machine that includes the grasping mechanism, grasps the wastes by the grasping mechanism, and feeds the wastes to the screening unit.

11. The waste sorting facility according to claim 10, wherein
the second working machine sprays the foam or the liquid to the wastes.

12. The waste sorting facility according to claim 1, wherein
the fluid spraying mechanism further includes a fourth spraying part that sprays the foam onto the conveying unit before the wastes are placed thereon.

13. A waste sorting method for sorting wastes, comprising the steps of:
spraying foam to a surface of a constituent that constitutes the wastes on a conveying unit;
conveying the constituent, to which the liquid has been sprayed, by the conveying unit;
spraying liquid to the constituent, to which the foam has been sprayed;
removing the constituent, to which the liquid has been sprayed, from the conveying unit by one or more first working machines disposed side by side in a conveying direction of the wastes so as to face the conveying unit; and
placing the constituent removed from the conveying unit by the one or more first working machines on one or more constituent placement parts disposed so as to face the conveying unit.
